(19) United States
(12) Patent Application Publication
(10) Pub. No.: US 2014/0058761 A1
(43) Pub. Date: Feb. 27, 2014

(54) Apparatus and Method for Analyzing Driving Performance Data

(71) Applicant: Insurance Services Office, Inc., Jersey City, NJ (US)

(72) Inventors: Avner Freiberger, Kfar-Saba (IL); David Izhaky, Tel-Aviv (IL); Amichai Painsky, Ra'anana (IL); Ariel Shamir, Jerusalem (IL); Zvika Bendet, Cresskill, NJ (US); Oren Steinberg, Tel-Aviv (IL); Asaf Tamir, Tel-Aviv (IL)

(73) Assignee: Insurance Services Office, Inc., Jersey City, NJ (US)

(21) Appl. No.: 13/972,134

(22) Filed: Aug. 21, 2013

Related U.S. Application Data
(60) Provisional application No. 61/691,283, filed on Aug. 21, 2012.

(51) Int. Cl. G06Q 40/08

(52) U.S. Cl. CPC G06Q 40/08
USPC 705/4

(57) ABSTRACT

A system for analyzing driving performance data is provided. The system and method include one or more devices in electronic communication with a network, the one or more devices including one or more sensors for obtaining raw data associated with operation of a vehicle by a driver. A driving performance engine in electronic communication with the device, the driving performance engine generates one or more granular driving events by defining values of one or more driving parameters by associating the one or more driving parameters to the raw data, compares the one or more granular driving events with one or more similar previous driving events of the driver or other drivers having similar driving parameters and values thereof, normalizes the one or more granular driving events of the driver based on the comparison, and processes the one or more granular driving events using the driving performance engine and one or more statistical models to calculate a performance or risk value for the driver.

### CROSS-REFERENCE TO RELATED APPLICATIONS

This application claims the benefit of U.S. Provisional Application Ser. No. 61/691,283 filed on Aug. 21, 2012, the entire disclosure of which is expressly incorporated herein by reference.

### BACKGROUND OF THE INVENTION

1. Field of the Invention

The present invention relates generally to gathering and analyzing information related to driving performance and behavior of a driver of a vehicle.

2. Related Art

Auto insurance today is based on the ability of insurance companies to use crude data to predict risk. Such crude data includes mainly personal background information, such as age, zip code, car type, claims history, financial credit score, etc. However, this crude data is often only partially correlated with actual driving risk. Most insurers use very similar crude data variables leading to insignificant differences between insurance programs, both from the point of view of the consumer and the insurer's ability to select its customers effectively in advance.

Realizing these new conditions, insurance companies have started using data originating from vehicle and driving monitoring devices to examine how people actually drive. In recent years, a few companies have been offering Usage Based Insurance (UBI) programs to consumers, where the price of the insurance policy is linked to data supplied from the actual vehicle. Most programs use mileage or duration of trips to discount insurance rates for low—mileage drivers. Programs use speed and acceleration measurements to discount safe drivers by tracking risky driving events (speeding, braking). UBI is considered an important step in making insurance more affordable, fair, and transparent to consumers.

### SUMMARY

The present disclosure provides a system and method for analyzing driving performance data. The system includes one or more devices in electronic communication with a network, the one or more devices including one or more sensors for obtaining raw data associated with operation of a vehicle by a driver. A driving performance engine is in electronic communication with the device, and generates one or more granular driving events by defining values of one or more driving parameters and associating the one or more driving parameters to raw data, compares the one or more granular driving events with one or more similar previous driving events of the driver or other drivers having similar driving parameters and values thereof, normalizes the one or more granular driving events of the driver based on the comparison, and processes the one or more granular driving events using one or more statistical models to calculate a performance or risk value for the driver.

### BRIEF DESCRIPTION OF THE DRAWINGS

The disclosed subject matter will be described with reference to the following description in conjunction with the figures. The figures are generally not shown to scale and any sizes or actual positions are not necessarily limiting.

FIG. 1 is a diagram showing a system and method in accordance with the present disclosure for analyzing driving performance data;

FIG. 2 is a diagram illustrating analysis performed by the system of a driving performance event;

FIG. 3 is a flowchart showing processing steps carried out by the system for automatically collecting driving performance data;

FIG. 4 is a flowchart showing processing steps carried out by the system for extracting and analyzing granular driving events;

FIG. 5 a flowchart showing processing steps carried out by the system for defining an event using sun angles;

FIG. 6 is a flowchart showing processing steps carried out by the system for setting a score for a vehicle for a particular time period;

FIG. 7 is a flowchart showing processing steps carried out by the system for providing feedback to a driver;

FIG. 8 is a flowchart showing processing steps carried out by the system for receiving and comparing insurance policy pricing;

FIG. 9 is a flowchart showing processing steps carried out by the system for handling insurance offers;

FIG. 10 is a flowchart showing processing steps carried out by the system for automatically detecting and reporting accident data;

FIG. 11 is a flowchart showing processing steps for searching a database for accident information; and

FIG. 12 is a diagram showing hardware and software components of the system.

### DETAILED DESCRIPTION

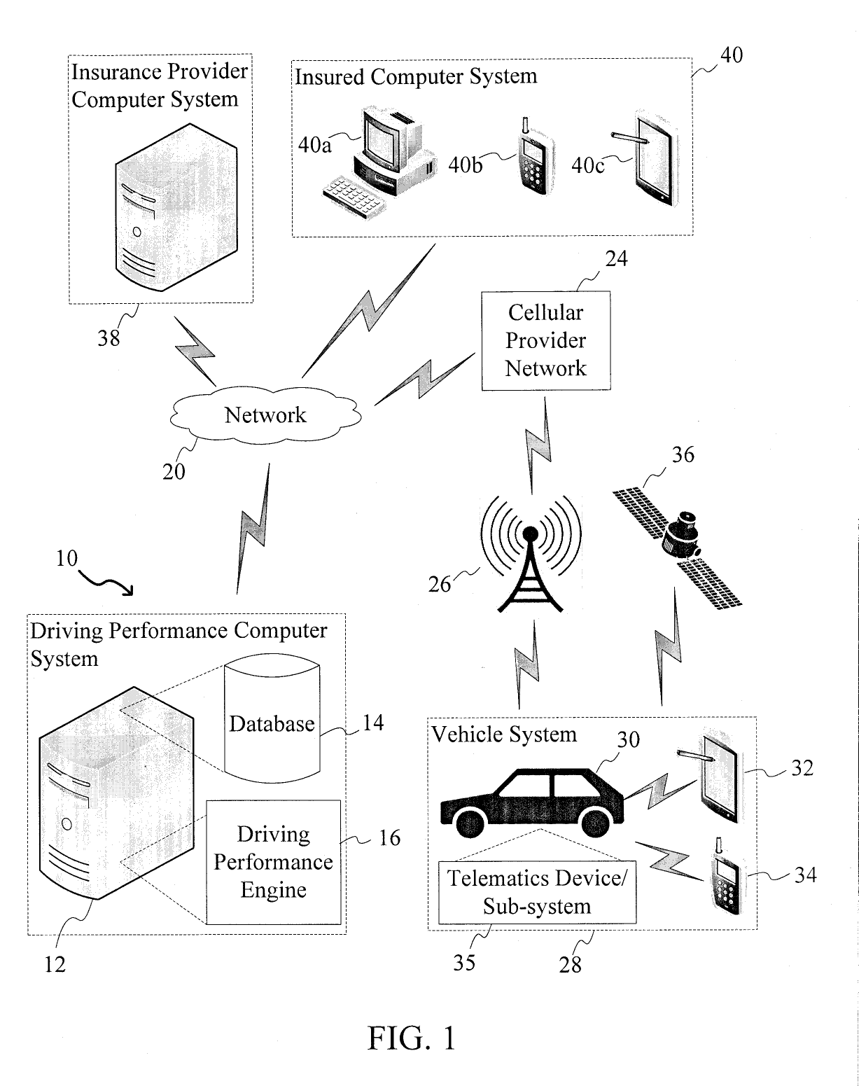

FIG. 1 is a diagram showing a system and method in accordance with the present disclosure for analyzing driving performance data. The system, indicated generally at 10, comprises a computer system 12 (e.g., a server) having a database 14 stored therein and a driving performance engine 16 executed by the computer system 12. The computer system 12 could be any suitable computer server (e.g., a server with a microprocessor, multiple processors, multiple processing cores) running any suitable operating system (e.g., Windows by Microsoft, Linux, etc.). The database 14 could be stored on the computer system 12, or located externally thereto (e.g., in a separate database server in communication with the system 10). As will be discussed in greater detail below, the engine 16, when executed by the computer system 12, provides the functionality described herein.

The system 10 communicates through a network 20 with one or more of a variety of computer systems. Network communication could be over the Internet using standard TCP/IP or UDP communications protocols (e.g., hypertext transfer protocol (HTTP), secure HTTP (HTTPS), file transfer protocol (FTP), electronic data interchange (EDI), dedicated protocol, etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format.

More specifically, the system 10 communicates with one or more vehicle systems 28 through a network 20, a cellular provider network 24, and one or more cellular antenna towers 26. The vehicle system 28 includes a vehicle 30 and one or more portable mobile devices (e.g., portable tablet computer 32, portable smartphone 34, and/or telematics sub-system 35 of the vehicle). An onboard diagnostics (OBD) system of the vehicle 30 and/or a telematics device 35 could communicate with the one or more devices 32, 34, 35 as a complement or supplement to the mobile device or as the main source for data collection (e.g., to identify the vehicle using vehicle identification number (VIN) validated through the OBD port). The vehicle 30 itself and/or the devices 32, 34, 35 could also communicate with a satellite system 36, such as for obtaining global positioning system (GPS) information. Information from the vehicle system 28 is transmitted periodically or continuously to the driving performance computer system 10 and/or stored in the database 14. However, at least some, if not all, of the functionality of the system 10 could be performed locally on devices 32, 34, 35 (e.g., personal computer, smart cellular telephone (Apple iPhone), tablet computer, etc.) programmed with software (e.g., a software application or “app”) in accordance with the present disclosure.

Further, the driving performance computer system 10 could electronically communicate with one or more insurance provider computer systems 38 and one or more insured computer systems 40 (e.g., personal computer system 40a, a smart cellular telephone 40b, a tablet computer 40c, or other devices). Additionally, or alternatively, an aggregator (e.g., online referrals agent), an insurance broker, etc. could also use and be in communication with the system.

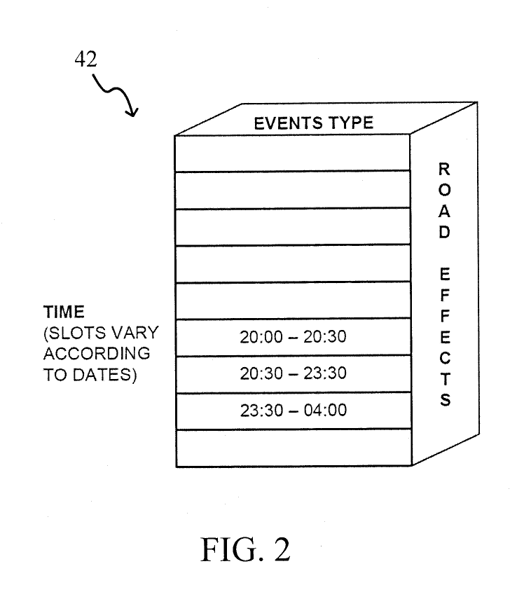

FIG. 2 is a diagram (e.g., schematic definition) illustrating analysis of a driving performance event carried out by the system. The diagram represents a multi-dimensional data structure 42 (e.g., a matrix, or “cube,” which could be, as in this example, 3-dimensional), where each dimension of the data structure 42 represents a different set of values that affect a single driving event (e.g., time, road, and traffic characteristics, weather and lighting conditions, etc.). The driving event is subsequently used to calculate a performance value (or score) for the driver. The performance value could be used by insurers to determine insurance coverage and/or an insurance rate and/or insurance discount for the driver. The data structure 42 could also be defined by two or more different sets of values.

The data structure 42 could comprise several “cells,” where each cell has a specific volume in the data structure. Each cell represents a driving event, and is defined by values of one or more driving parameters (e.g., three parameters). The driving parameters discussed above could be characteristics of the road in which the driver was driving at the time the sensor data was detected, time of day when the sensor data was detected, event type determined from the raw data, driver's behavior type, lighting conditions effects on the driver, etc. The values and ranges of the driving parameters could be periodically or continuously updated, either according to detected driving performance data or according to objective circumstances (e.g., construction on a specific road).

Each driving parameter has multiple optional values or value ranges. Each cell is defined by the value and/or value range of the relevant driving parameters. For example, if a specific driving parameter (e.g., road characteristics) has 10 optional values or ranges, and two other driving parameters have 8 optional values or ranges, then the number of optional cells is 640, which represents the number of permutations for each optional value of each driving parameter.

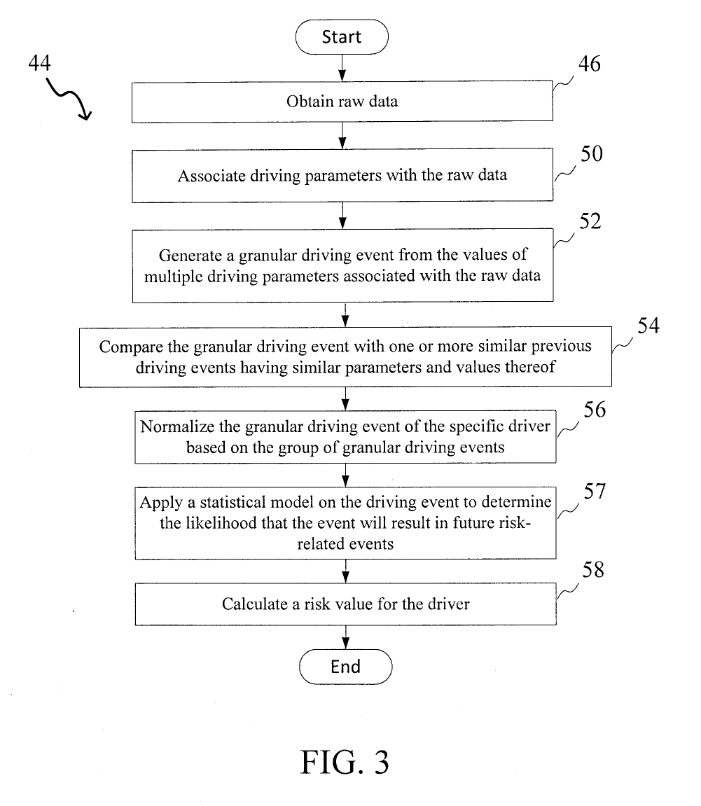

FIG. 3 is a flowchart showing processing steps 44 carried out by the system for automatically collecting driving performance data. In step 46, the system obtains raw data (or sensor data) of a driver and/or driving parameters of a driving event. Raw data is data received from a device before any processing or analysis. Such raw data could be obtained in real time from a mobile device, and/or telematics device, and/or retrieved from a database of stored raw data or other supporting data. Such raw data could include sensor data, such as from an accelerometer, gyroscope, GPS, vehicle systems data related to the operation of the vehicle, vehicle speed, changes in vehicle speed, time in which the sensor data was detected, vehicle location at the time the sensor data was detected, use of phone while driving, characteristics of the road, traffic, weather, and lighting conditions, etc. In step 50, the system associates driving parameters (discussed below in more detail) with the raw data. The system defines (and/or updates) values for one or more driving parameters, where each driving parameter could have a range of possible values (such as for a particular road segment).

In step 52, the system generates (and/or obtains) a granular driving event according to the values of multiple driving parameters associated with the raw data (e.g., for the particular road segment evaluated). A granular driving event is created by grouping raw data representing a specific driving event, and could be one of thousands of possible driving events. The specific granular driving event is defined by having specific values for specific driving parameters. Grouping is performed by analyzing the different parameters of an event according to a set of rules. For example, a braking event on a highway in a rainy weekend night could be analyzed by grouping the braking intensity and dynamics (e.g., acute distribution and high peaks of deceleration force, or high velocity at beginning of event, etc.), the location (e.g., upon identifying the specific segment of the highway, etc.), the characteristics of the road segment (e.g., relatively close to an intersection, type of highway, etc.), the characteristic of traffic (e.g., typical speed of other vehicles on that road segment, during congestion, etc.), the weather and lighting conditions (e.g., rainy day, night time, etc.), the time of day and day of week (e.g., late night on a weekend, etc.), etc.

In step 54, the system compares the specific granular driving event with one or more similar previous driving events (e.g., a group of driving events) having similar parameters and values thereof. In other words, the system looks for similar driving events of the driver or other drivers to compare with the specific granular driving event of the specific driver. For example, the system could determine a distance between the specific granular driving event and one or more driving events of the group of driving events. The system could calculate a similarity value between a granular driving event and one or more driving events (e.g., a group of driving events) according to values of one or more driving parameters. In this way, the system compares the specific granular driving event to known events of the same (or similar) values.

In step 56, the system normalizes the granular driving event of the specific driver based on the group of similar previous driving events (e.g., normalizing the driving values of the granular driving event by comparing such values with a group of driving events having similar parameters and values thereof). For example, a certain braking event on a certain road segment could be normalized by comparing the driving event to other braking events on that road segment or similar road segments to determine that the driving event is either very common (perhaps due to a pothole in that location) or very exceptional. Another example could be comparing a speeding event to other speeding events on that road segment or similar road segments to determine if it is indeed a speeding event or that most other drivers actually drive the same velocity on such road segment. In this way, a specific driving event of a particular driver can be compared to previous driving events having similar values of the same (or similar) driving parameters (e.g., events under similar road conditions). The data of the granular driving event could then be analyzed to determine how far this value is from a pre-defined “normal” (or reference) set of data. For example, the system processes the raw data with respect to a specific driver's performance on entering junctions of particular characteristics at a specific time (e.g., 2:00 PM), and compares it with the raw data of other drivers in similar driving conditions. This comparison normalizes the raw data, driving performance result, and/or driving style of the specific driver relative to other drivers under similar conditions. This is particularly useful for insurance companies, as a driver's driving style could imply whether the driver is more likely to perform risky operations (e.g., which result in accidents and insurance claims).

The system could generate a set of values representing how each driving event and/or driving event type of a specific driver and/or vehicle is ranked in relation to the norm. For example, a driver could be ranked in the 90^{th} percentile for highway behavior relative to the relevant population and only in the 75^{th} percentile for junction left turns relative to the relevant population. Each such value could also be linked to other values relating to the risk of each such driving event or driving behavior. For example, being in the 90^{th} percentile in highway behavior may not be as risky as being in the 75^{th} percentile in junction left turns. The risk associated with each such value could be defined by multiplying each such value by a predefined set of risk coefficients relating to a distance from the norm, frequency, scarcity and severity of each such event.

In step 57, the system processes the one or more granular driving events using one or more statistical models and/or algorithms to determine the likelihood that the granular driving events will result in future risk-related events, such as an insurance claim, an accident, a near-accident event (e.g., extremely risky events that are not used as part of the raw driving variables), or other driving related behaviors such as fuel efficient driving, high maintenance driving, etc. The system uses the driving parameters and their values, along with their severity and normative levels, and correlates them with known frequency and/or cost of insurance claims data. The system could also associate values of different driving parameters that are likely to cause risk-related events. The statistical model involves a target function in which the variables are different risk-related events. In step 58, the system calculates a risk value for the driver (and/or a specific granular driving event or a group of such events) by processing the output of the statistical model(s) and/or algorithm(s) discussed above, such as by summing events for the driver.

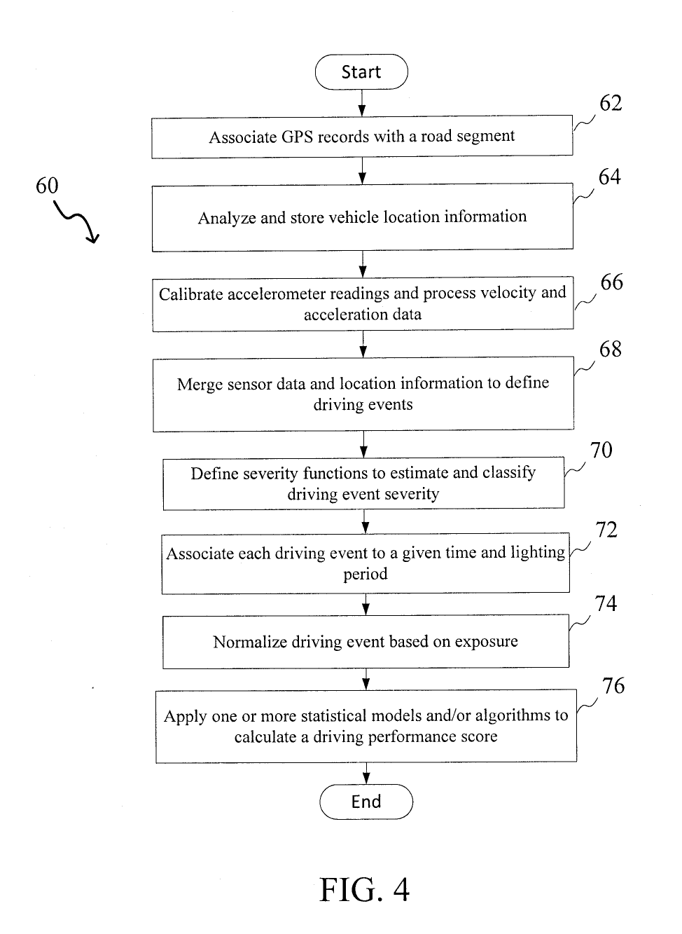

FIG. 4 is a flowchart showing processing steps 60 for extracting and analyzing granular driving events. In step 62, the system associates GPS records (e.g., on a map) with a specific road segment. Missing or dislocated GPS readings could simply be omitted, or corrected and matched to the road segment actually driven (e.g., driving segment). Additionally, map road segments could be preprocessed and classified. For example, the road segments could be classified as highways (e.g., curvature, link (e.g., highway exit, 270 degree ramp), etc.), roundabouts, intersections, parking lots, etc.

In step 64, the system analyzes a location of a vehicle and stores the information (e.g., as metadata) for a driving segment. In step 66, the system calibrates accelerometer readings and data (e.g., according to the orientation and possible movement of the accelerometers in the vehicle), and subsequently processes velocity and acceleration data (and/or raw GPS data) to extract driving events. In step 68, the system groups sensor data and location information to define specific granular driving events. Driving events could include braking events (e.g., slow down, full stop), turning events (e.g., curved road, active turning), acceleration events (e.g., acceleration from full stop, increasing speed), speeding events (e.g., based on how others speed on the same road segment), etc.

In step 70, the system defines one or more severity functions (e.g., relating severity to distribution of acceleration/speed) to estimate the severity for each event (and/or location type), and/or classify the event into a severity level. The severity level could be indicated to a user by color (e.g., red, green, yellow, etc.) in a graphical user interface. Parameters for the severity of each event are calculated statistically based on event type, sub-type, and road segment type and characteristics (but some rare event combinations could be omitted). This defines a set of driving data variables (DDVs), prior to the application of time frames. DDVs include extended information of a single granular driving event (e.g., braking before an intersection in the evening).

In step 72, the system associates each driving event to a given time period (e.g., day of week and timeslot within the day) and lighting period (e.g., night, twilight or day), and then for each time period defined, calculates driving exposure (e.g., driving risk). A set of time periods/frames/codes could be defined based on the normative exposure of a road segment for a particular time period (e.g., hour) of a particular day of the week (e.g., Monday morning, Saturday evening, etc.), but also to other behavioral, road, traffic, or weather conditions. Table 1 below shows an example of such defined time periods (e.g., time codes).

TABLE 1

| Start | End | Start | End | | |
|---|---|---|---|---|---|
| week- | week- | Day | Day | | |
| day | day | code | code | value | Code |
| 2 | 6 | 0 | 20 | WEEKDAY_LATE_EVENING | 1 |
| 2 | 6 | 20 | 320 | WEEKDAY_NIGHT | 2 |
| 2 | 6 | 320 | 500 | WEEKDAY_EARLY_MORNING | 3 |
| 2 | 5 | 500 | 900 | WEEKDAY_MORNING_RUSH | 4 |
| 2 | 5 | 900 | 1500 | WEEKDAY_NOON | 5 |
| 2 | 5 | 1340 | 1840 | WEEKDAY_AFTERNOON_RUSH | 6 |
| 2 | 6 | 1840 | 2200 | WEEKDAY_EVENING | 7 |
| 2 | 6 | 2200 | 2400 | WEEKDAY_LATE_EVENING | 8 |
| 6 | 6 | 500 | 900 | FIRDAY_MORNING_RUSH | 9 |
| 6 | 6 | 900 | 1500 | FRIDAY_NOON | 10 |
| 6 | 6 | 1340 | 1840 | FRIDAY_AFTERNOON_RUSH | 11 |
| 1 | 1 | 0 | 600 | WEEKEND_NIGHT | 12 |
| 1 | 1 | 600 | 1000 | WEEKEND_MORNING | 13 |
| 1 | 1 | 1000 | 1940 | WEEKEND | 14 |
| 1 | 1 | 1940 | 2360 | WEEKEND_EVENING | 15 |
| 7 | 7 | 0 | 600 | WEEKEND_NIGHT | 12 |
| 7 | 7 | 600 | 1000 | WEEKEND_MORNING | 13 |
| 7 | 7 | 1000 | 1940 | WEEKEND | 14 |
| 7 | 7 | 1940 | 2360 | WEEKEND_EVENING | 15 |

In the above example, combining the fifteen different time codes and location based driving event statistics results in 10,800 different variables (e.g., 720*15=10,800).

In step 74, the system normalizes the driving event based on exposure of the particular road segment. In step 76, the system models variables (e.g., annual number of claims and/or severity thereof) using one or more statistical models and/or algorithms (e.g., a Poisson regression model). More specifically, dependent variables could be used as the input for the statistical models, where the dependent variables are the normalized DDV's and the exposure of each time frame. Dedicated stepwise procedures could be incorporated, due to the large number of variables, to select a subset of variables to be included in the model. The system could then validate the model(s) and, if multiple models are developed, choose (or have the user choose) the best models (in terms of predictability, stability, etc.). The one or more models could then produce an estimated Lambda (e.g., the mean of the Poisson process).

Optionally, a sub-set of a small number of explanatory variables could be randomly selected to fit an initial model. The system could then apply a traditional stepwise procedure to detect an optimal sub-sub-set of variables for the initial model. This procedure could then be repeated until a model is fit using the aggregated sub-sub-sets of variables. Then a final stepwise procedure could be used to remove the insignificant variables.

The Lambdas of all of the drivers could be used to fit a log-normal loss distribution (e.g., a mixture of log-normal distributions can also be used). A score function could extract the individual score from the fitted loss distribution, such as by transforming the log-normal distribution of the Lambdas to a log-normal distribution constrained between 0 and 100. The score of subsequent months could be smoothed with respect to the score of the initial months, such as by calculating a weighted score using the 0.50-0.30-0.20 rule for previous months or by using a credibility procedure which takes into account the variability in driving safety of individual drivers and the variability between the drivers over the months.

The system could utilize any of a number of different types of driving parameters, discussed above. One such driving parameter to define a driving event is an event type. The event type could be determined according to data received from the vehicle's sensors (e.g., brake type, brake duration, force applied during the brake, peak of brake, duration between brakes, etc.). Other event types could include full stop or deceleration towards an intersection in different velocity bands, right and left turns in intersections, highway speeding in different velocity bands or in relation with the driving of others in the same road segments, full stop or deceleration on a road in different velocity bands, speed changes in different roads and speed limits, curves and merges negotiations, low speed speeding, parking maneuvers, tailgating in different velocity bands and different road types, distracted driving in different velocity bands and different road types, etc.

Another parameter for defining the driving event could be road characteristics. The system obtains, among other raw data, the location of each driving event, such as from a GPS receiver in the vehicle. The analyzing system further obtains data related to roads in which the driver normally drives (e.g., the averaged speed at a specific road at the same time of the event) to determine how the driver was driving (e.g., whether the driver was driving at the same velocity as the traffic or faster). The analyzing system could obtain the road type (e.g., a highway, a main street, country road, alley, etc.). The driver is expected to behave differently on different roads, and on different road characteristics (e.g., the locations of traffic lights, road signs, junctions, the frequency of driving on the road by the driver, etc.). As such, detection of high deceleration before a junction is defined by the system as a different driving event than detection of high deceleration on a highway.

Another parameter for defining the driving event could be the behavior that is associated with the event, determined according to the raw data obtained from the sensors. The behavior could be, for example:
1. Intersection awareness—braking and speeding events towards and in an intersection, as identified by geographical information systems, as well as abrupt lane changes or aggressive accelerations in an intersection;
2. Highway behavior—tailgating, braking and speeding on high speed roads;
3. Aggressiveness—aggressive speeding, such as detected by frontal accelerations;
4. Distracted driving—recurring events while speaking on the phone or not paying attention to the road or traffic;
5. Night driving—such as making left turns to cross traffic in dark intersections;
6. Congestion awareness—low speed braking, rush hour maneuvers, ramp merging, low speed accelerations;
7. Curve negotiation—speeding toward a curve or a turn, braking inside a curve or turn, accelerating out of the curve;
8. Parking maneuvers—pulling in and out of a driveway or braking and accelerating in a parking lot; and/or
9. Weather awareness—speeding on wet or snowy roads, maintaining a safe distance in bad weather or lighting.

Another parameter for defining the driving event is an event time. The time could be a time of day, a holiday, weekend, etc. The time associated with the driving event is not defined by simple day/night, but according to predefined parameters, such as predicted congestion, season, etc. For example, the time associated with the driving event could be selected from 7:30-8:30 which is a morning congestion, 8:30-15:30 which is day routine, 15:30-17:30 which is afternoon congestion 17:30-18:30 which is “at sunset,” etc. Similarly, the parameter value for an event occurring at night on a weekday could be different from an event occurring at night on weekends.

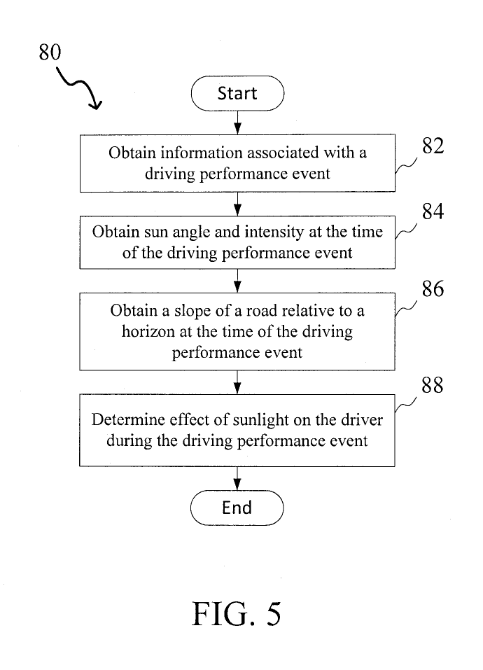

FIG. 5 is a flowchart showing the processing steps 80 for defining an event using lighting conditions and sun angles. More specifically, another parameter for defining the driving event could be the angle at which the sun is visible to the driver. In step 82, the system obtains information associated with a driving performance event (e.g., a date, time, road, vehicle location, direction of travel of the vehicle, etc.). In step 84, the system calculates a sun angle and intensity at the time of a driving performance event (e.g., sun angle relative to a horizon), and/or at different times throughout the day. Such an angle is determined as a function of sun angle parameters (e.g., the vehicle's direction on the specific road, light intensity at a given time of the day, the slope of the road relative to the horizon, time of sunrise on a specific date, etc.). In step 86, the system obtains a slope of the road relative to the horizon, such as by according to the location of the vehicle at the time of the driving performance event. In step 88, the system determines the effect of sun light on the driver during the driving performance event, such as according to the angle between the sun and the vehicle's slope relative to the horizon at the time of the driving performance event. In this way, the system obtains the sun angle parameters and determines the effects of sun light on the driver accordingly. This information could be used by the model discussed above to enhance driving risk estimation performed by the system.

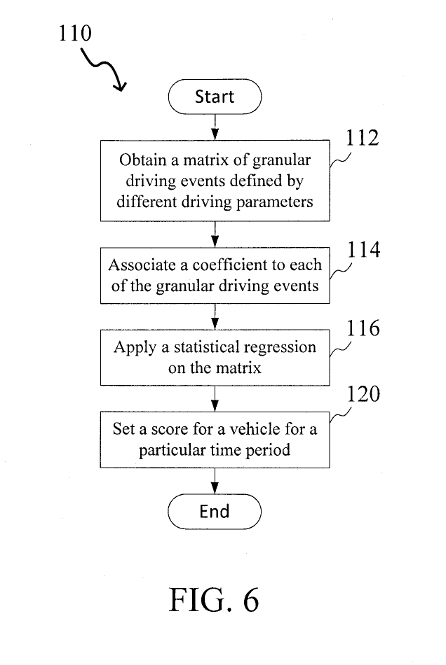

FIG. 6 is a flowchart showing processing steps 110 for setting a score for a vehicle for a particular time period. In step 112, the system obtains a matrix of granular driving events defined by different driving parameters. In step 114, the system associates a coefficient to each of the granular driving events. In step 116, the system applies a statistical regression on the matrix to correlate the cells of the matrix and the corresponding coefficients with the required target function (which represents the risk-related events). The statistical regression optimizes the coefficients and associates the optimized coefficients with the specific granular driving event in the matrix. In step 120, the system then sets a score for a vehicle for a particular time period by analyzing each new piece of data received at the system based on the driving variables.

The statistical models, algorithms, and/or methods could correlate each driving event value with certain target functions. Such target functions could be a sub-set of predefined extreme risky events that are extracted from driving data (of the specific driver or plurality of drivers). Other target functions could be actual accidents detected and not reported to the insurer, and/or actual claims provided to (or by) insurers by frequency and/or cost of claims. Other target functions could be fuel consumption (based on fuel efficient driving), or vehicle maintenance. Each such target function (or group of such target functions) could be correlated to the driving events by means of statistical regressions to determine significant events in the driving of the specific driver. Such regressions could be performed regularly on all of the data (or occasionally) to create the risk coefficients.

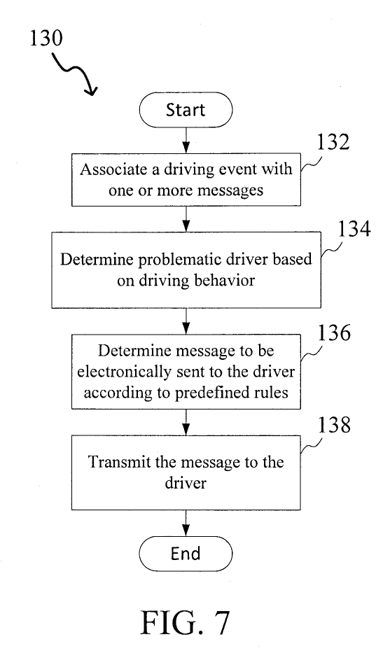

FIG. 7 is a flowchart showing processing steps 130 for providing feedback to a driver or to a vehicle owner or to a fleet manager. The system can provide feedback to the driver according to the analyzed driving performance data, and its relation to performance, risk and normalization. The feedback could include risk and safety levels determined according to the driving performance data (as discussed above). The feedback could include potential or actual changes in insurance costs according to specific actions or events performed by the driver. For example, the system could alert the driver that a specific driving pattern recurring over time results in a five percent increase in insurance costs. This way, drivers or vehicle owners could understand the implications of driving habits and are incentivized to improve.

In step 132, a feedback module of the system associates a driving event with one or more messages. In step 134, the system selects an appropriate message for the driver based on the driving behavior of the driver, as determined from the sensor data, raw data, etc. In step 136, the system determines a message (e.g., driving variables) to be sent to the driver according to predefined rules (e.g., age, gender, mileage, etc.). In step 138, the system transmits the message to the user (e.g., email, SMS, web, etc.). For example, the feedback module could determine that a specific driver is problematic and likely to be considered risky in entering a highway on weekend evenings, and send a message to the driver accordingly. The driving variables shown to the driver could be determined according to distance from the norm, prediction of risk, and/or prediction of effect of behavioral coaching. Focusing the messages and/or driving variables on known behavioral aspects of the daily routines of drivers enables drivers to easily relate to those behaviors and act on the road accordingly.

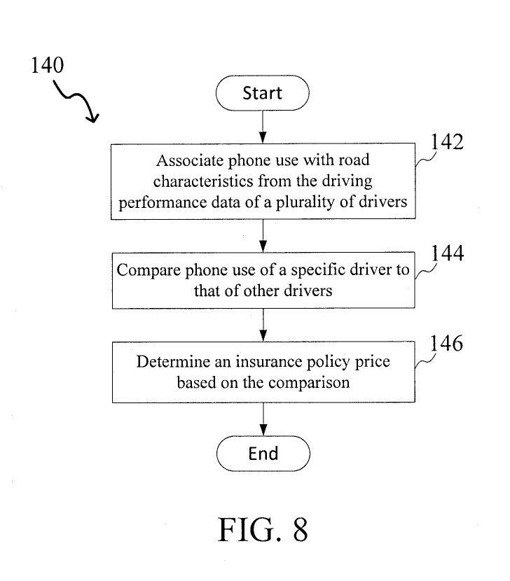

FIG. 8 is a flowchart showing processing steps 140 for receiving and comparing insurance policy pricing. In step 140, the system associates phone use (e.g., number and duration of phone calls while driving) with driving performance from the driving performance data of a plurality of drivers. Phone usage information could be obtained from the mobile device and/or records kept by a cellular carrier. In step 144, the system compares the phone use of a specific driver while driving to that of other drivers. Such comparison could be narrowed to comparison at congestion, highways, narrow streets, holding the phone or when hands-free and the like. In step 146, the system determines or receives an insurance policy price based on the comparison. In this way, the system is able to determine an insurance policy price based on the phone use of other drivers, as well as the driving performance of a specific driver.

The system could determine a potential driving risk for a specific driver according to the granular driving events. One driver could have a potential driving risk of distraction, while another driver could have a potential driving risk of severe brakes before junctions. The insurance company could offer different insurance rates, discounts or other benefits for each driver according to the specific driving risk. In some cases, one driver could be associated with multiple potential driving risks, at different levels, and receive an insurance offer according to the multiple potential driving risks. The system could update the driver's performance data in a periodical manner. Updating the driver's performance data could result in updating the risk associated with the driver, and updating the insurance rate, discount, and/or coverage of the driver accordingly.

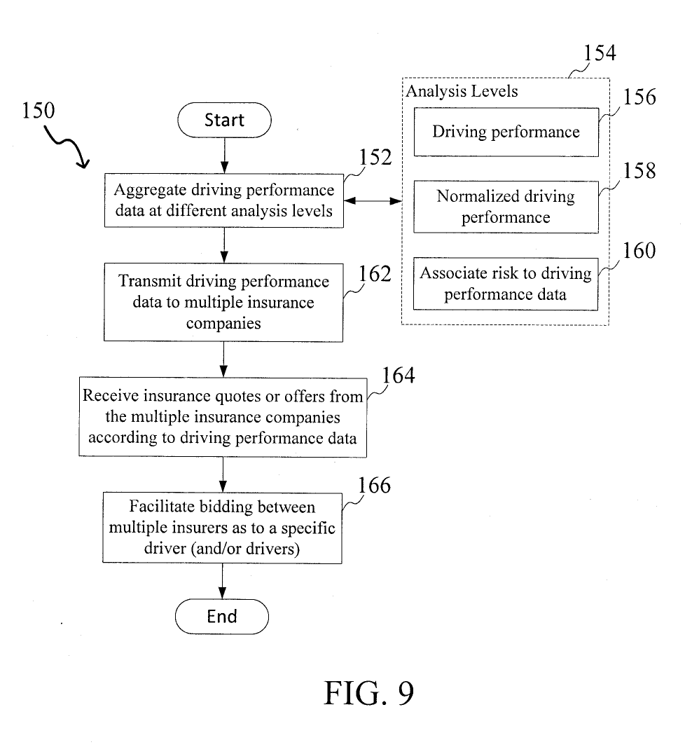

FIG. 9 is a flowchart showing processing steps 150 for handling insurance offers. In step 152, the system could aggregate driving performance data at different analysis levels 154. The different analysis levels could include driving performance 156 (e.g., a number of brakes with a force higher than a predefined threshold, any sub-set of the other driving events and behaviors, etc.), normalized driving performance 158 (e.g., by comparing the driving performance at a granular driving event to other driving performance of the same granular driving events), associate risk to the driver's performance data 160, etc. In step 162, the system transmits the driving performance data to multiple insurance companies. In step 164, the system receives insurance quotes or offers according to the driving performance data of the specific driver. In step 168, the system could facilitate bidding between multiple insurers, as to the specific driver or drivers. This allows an insurer to choose and/or bid on certain types of drivers.

The system could approve the use of driving events and driving behaviors by insurance industry regulators. The method then offers the pre-approved models to insurers, enabling them to easily and quickly use the data, without needing to go through the long regulatory process. The method could also include pre-approved risk indexes and risk models, as were defined by the system. Insurers could then choose to use any such data at different levels, from basic driving events, through risk data, to rating models. These choices would enable insurers to pick which drivers fit their portfolio best according to their business needs. The system could present to insurers the possible risk or financial results of having a specific driver or types of drivers in their portfolio, and insurers could use this data to select drivers as well as to match the appropriate rate, discount or benefit to the driver or group of drivers.

The system could refer drivers to insurers based on the driving performance data or risk levels of the driver, based on a short period of driving. For example, a driver could use the system for analyzing driver's performance data for one month before purchasing a policy, and then the data collected by the system for analyzing driver's performance data is presented to insurers along with the analyzed data or the risk levels, and insurers could choose to sell a policy to the driver based on such data. At this level, the presentation of the data to the insurers could be completely anonymized, providing only the risk levels or the aggregated driving performance data without compromising any personal data of the driver. In some cases, the driver could choose to reveal additional personal information, such as age, zip code, claims history and car type to improve the chances of getting a better insurance deal.

The system could use the driving performance data and the associated risk variables in other lines of insurance except for auto insurance, such as home insurance or health insurance, using the driving risk levels to attest to the overall risk of the individual in other fields. Similarly, the driver could also choose to present the driving performance data to employers or potential buyers of the vehicle.

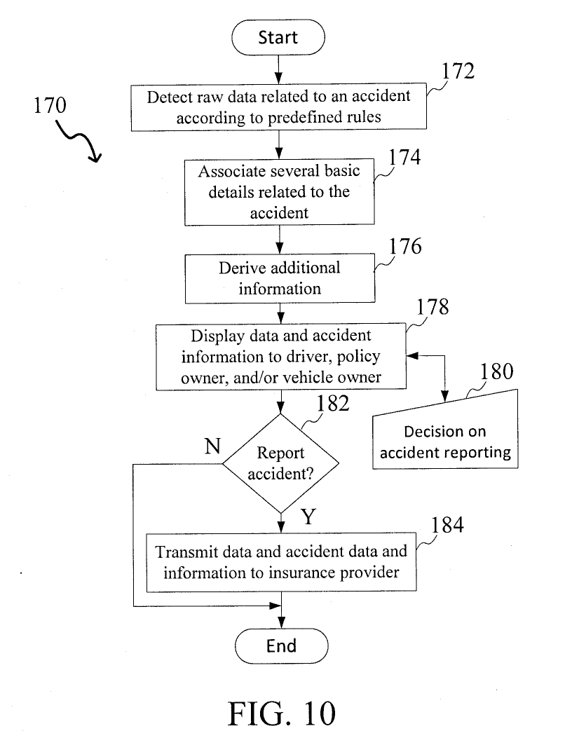

FIG. 10 is a flowchart showing processing steps 170 for automatically detecting and reporting accident data. The data related to accidents could be made available by the driver or be requested by insurers based on claims files that are reported by the driver or third parties claimants. In step 172, the system detects raw data related to an accident according to predefined rules (e.g., accidents that are not reported nor claimed). In step 174, the system associates several basic details related to the accident, such as the velocity of the vehicle (before, during and after impact), location of the accident, force of impact in different axes, environmental attributes (weather, lighting, congestion as could be correlated with data from third party service providers), etc. In step 176, once those elements are evaluated, additional information could be derived, such as the type of the accident (frontal, side, etc.), severity of impact, expected damage type, expected damage cost, contribution of each party to the accident, and the respective liability, etc.

In step 178, the accident data and accident information determined by the system is displayed to the driver, policy owner, and/or vehicle owner. In step 180, the driver, policy owner, or the vehicle owner inputs any revisions in the report generated by the system, and decides whether to report the accident. In step 182, the system determines whether the driver, policy owner, or vehicle owner desires to report the accident based on the input. If not, the process ends. Otherwise, in step 184, the system transmits data and accident information to an insurance provider. In this way, the system could present the data to the driver first, enabling the driver or the vehicle owner to decide whether he or she wants to report the accident and/or the data to the insurer.

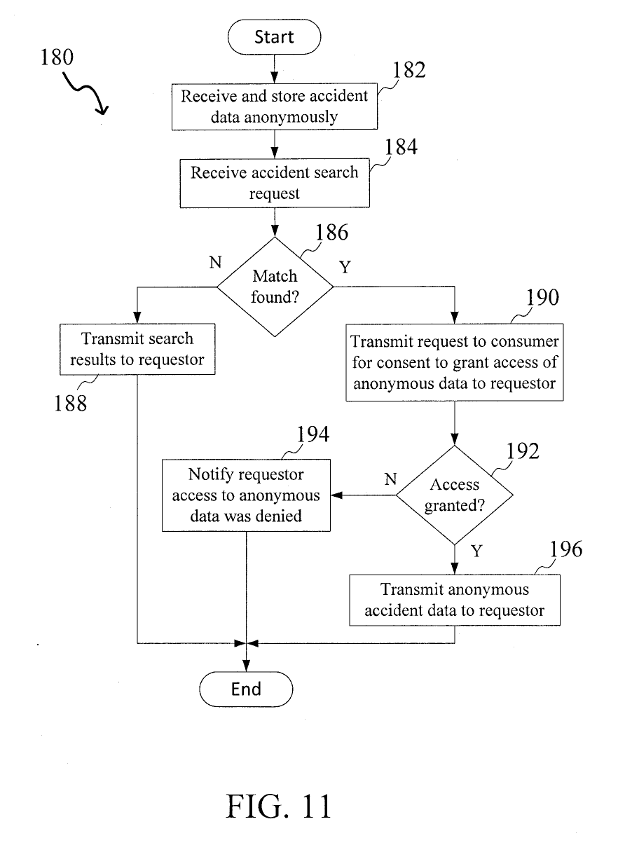

FIG. 11 is a flowchart showing processing steps 180 for searching a database for accident information. This allows an insurance provider to ask for accident data based on an actual insurance claim received. In step 182, the system receives and stores accident data anonymously. In step 184, the system receives an accident search request from an insurer or other a requestor (e.g., search criteria could include time, location, car type, etc.). In step 186, the system determines whether there is data that matches the search inquiry of the requestor. If the system determines that there is not any matching data, then in step 188, the system transmits the search results to the requestor to notify that there is no data matching the search request. Otherwise, if the system determines that there is matching data, then in step 190, the system transmits a request to the driver or vehicle owner associated with the matching data. The request seeks consent from the driver or vehicle owner for the system to grant the requestor access of the anonymous data. In step 192, the system determines whether the driver or vehicle owner has granted access to the anonymous data. If access has not been granted, then in step 194, the system notifies the requestor that access to the anonymous matching data was denied. Otherwise, if the system determines that access has been granted, then in step 196, the system transmits the anonymous accident data to the requestor. Alternatively, the data could be sent automatically or anonymously without the driver's or vehicle owner's consent.

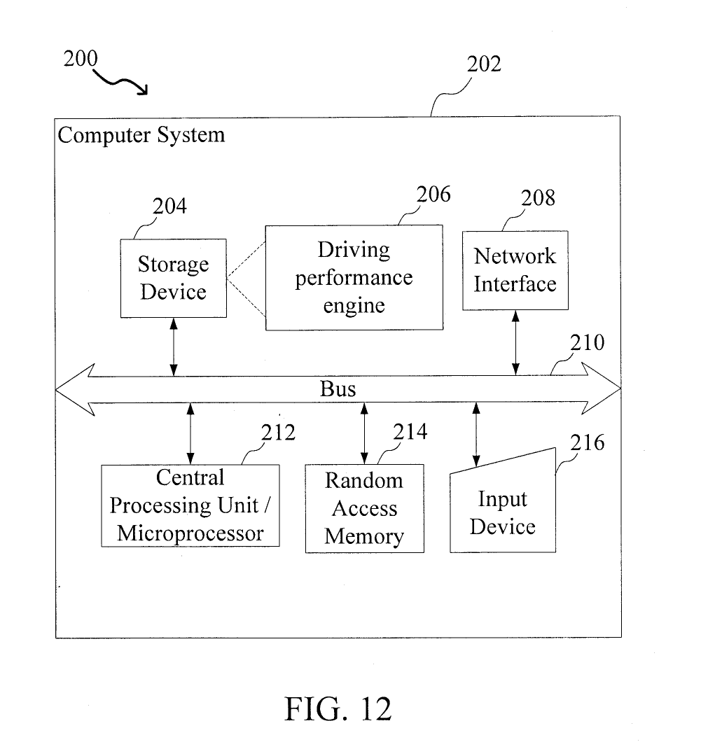

FIG. 12 is a diagram showing hardware and software components of the system 200 capable of performing the processes discussed above. The system 200 comprises a computer system 202 which could include a storage device 204, a network interface 208, a communications bus 210, a central processing unit (CPU) (microprocessor) 212, a random access memory (RAM) 214, and one or more input devices 216, such as a keyboard, mouse, etc. The computer system 202 could also include a display (e.g., liquid crystal display (LCD), cathode ray tube (CRT), etc.). The storage device 204 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The computer system 202 could be a networked computer system, a personal computer, a smart phone, etc.

The present invention could be embodied as a data matching software module or engine 206, which could be embodied as computer-readable program code stored on the storage device 204 and executed by the CPU 212 using any suitable, high or low level computing language, such as Java, C, C++, C#, .NET, etc. The network interface 218 could include an Ethernet network interface device, a wireless network interface device, or any other suitable device which permits the server 202 to communicate via the network. The CPU 212 could include any suitable single- or multiple-core microprocessor of any suitable architecture that is capable of implementing and running the driving performance program 206 (e.g., Intel processor). The random access memory 214 could include any suitable, high-speed, random access memory typical of most modern computers, such as dynamic RAM (DRAM), etc.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A system for analyzing driving performance data, comprising:
one or more devices in electronic communication with a network, the one or more devices including one or more sensors for obtaining raw data associated with operation of a vehicle by a driver; and
a driving performance engine in electronic communication with the one or more devices, the driving performance engine generating one or more granular driving event by defining values of one or more driving parameters associated with the raw data, comparing the one or more granular driving events with one or more similar previous driving events of the driver or other drivers having similar driving parameters and values thereof, normalizing the one or more granular driving events of the driver based on the comparison, and processing the one or more granular driving events using one or more statistical models to calculate a risk or performance value for the driver.

2. The system of claim 1, wherein the driving performance engine transmits the risk or performance value to an insurance provider computer system, and receives insurance coverage or cost information from the insurance provider computer system based upon the risk or performance value.

3. The system of claim 1, wherein the one or more driving parameters include a driving event type, road characteristics, traffic characteristics, driver behavior, driving event time, and weather and lighting.

4. The system of claim 1, wherein the driving performance engine determines lighting conditions and a sun angle by obtaining a slope of a road relative to a horizon and determining an effect of sun light on the driver during the one or more granular driving events.

5. The system of claim 1, wherein the driving performance engine provides feedback to the driver or vehicle owner according to analyzed driving performance data.

6. The system of claim 5, wherein the feedback includes changes in insurance costs according to driving performance of the driver.

7. The system of claim 1, wherein the risk value represents the likelihood that the one or more granular driving events will result in future risk-related events.

8. The system of claim 1, wherein the raw data includes location information and sensor data.

9. The system of claim 1, wherein the driving performance engine defines one or more severity functions to estimate a severity for the one or more granular driving events.

10. The system of claim 1, wherein the system facilitates bidding for the driver between a plurality of insurance providers.

11. A method for detecting driving performance data comprising:
electronically obtaining raw data associated with operation of a vehicle using one or more devices having one or more sensors, the one or more devices in electronic communication with a network;
processing the raw data using a driving performance engine in electronic communication with the one or more devices;
generating using the driving performance engine one or more granular driving events by defining values of one or more driving parameters associated with the raw data;
comparing using the driving performance engine the one or more granular driving events with one or more similar previous driving events of the driver or other drivers having similar driving parameters and values thereof;
normalizing using the driving performance engine the one or more granular driving events of the driver based on the comparison; and
processing the one or more granular driving events using the driving performance engine and one or more statistical models to calculate a risk or performance value for the driver.

12. The method of claim 11, further comprising transmitting, by the driving performance engine the risk value to an insurance provider computer system, and receiving insurance coverage or cost information from the insurance provider computer system based upon the risk value.

13. The method of claim 11, wherein the one or more driving parameters include a driving event type, road characteristics, traffic characteristics, driver behavior, driving event time, and weather and lighting conditions.

14. The method of claim 11, further comprising determining, by a driving performance engine, lighting conditions and a sun angle by obtaining a slope of a road relative to a horizon and determining an effect of sun light on the driver during the one or more granular driving events.

15. The method of claim 11, wherein the driving performance engine provides feedback to the driver or the vehicle owner according to analyzed driving performance data.

16. The method of claim 15, wherein the feedback includes changes in insurance costs according to driving performance of the driver.

17. The method of claim 11, wherein the risk value represents the likelihood that the one or more granular driving events will result in future risk-related events.

18. The method of claim 11, wherein the raw data includes location information and sensor data.

19. The method of claim 11, further comprising defining using the driving performance engine one or more severity functions to estimate a severity for the one or more granular driving events.

20. The method of claim 11, wherein the system facilitates bidding for the driver between a plurality of insurance providers.

21. A computer-readable medium having computer-readable instructions stored thereon which, when executed by a computer system, cause the computer system to perform the steps of:
electronically obtaining raw data associated with operation of a vehicle using one or more devices having one or more sensors, the one or more devices in electronic communication with a network;
processing the raw data using a driving performance engine in electronic communication with the one or more devices;
generating using the driving performance engine one or more granular driving events by defining values of one or more driving parameters associated with the raw data;
comparing using the driving performance engine the one or more granular driving events with one or more similar previous driving events of the driver or other drivers having similar driving parameters and values thereof;
normalizing using the driving performance engine the one or more granular driving events of the driver based on the comparison; and
processing the one or more granular driving events using the driving performance engine and one or more statistical models to calculate a risk or performance value for the driver.

22. The method of claim 21, further comprising transmitting, by the driving performance engine the risk value to an insurance provider computer system, and receiving insurance coverage or cost information from the insurance provider computer system based upon the risk value.

23. The method of claim 21, wherein the one or more driving parameters include a driving event type, road characteristics, traffic characteristics, driver behavior, driving event time, and weather and lighting conditions.

24. The method of claim 21, further comprising determining, by a driving performance engine, lighting conditions and a sun angle by obtaining a slope of a road relative to a horizon and determining an effect of sun light on the driver during the one or more granular driving events.

25. The method of claim 21, wherein the driving performance engine provides feedback to the driver or the vehicle owner according to analyzed driving performance data.

26. The method of claim 25, wherein the feedback includes changes in insurance costs according to driving performance of the driver.

27. The method of claim 21, wherein the risk value represents the likelihood that the one or more granular driving events will result in future risk-related events.

28. The method of claim 21, wherein the raw data includes location information and sensor data.

29. The method of claim 21, further comprising defining using the driving performance engine one or more severity functions to estimate a severity for the one or more granular driving events.

30. The method of claim 21, wherein the system facilitates bidding for the driver between a plurality of insurance providers.
